(19) United States
(12) Patent Application Publication
(10) Pub. No.: US 2019/0037949 A1
(43) Pub. Date: Feb. 7, 2019

(54) HAT COOLING SYSTEM

(71) Applicant: Frisner Nelson, Orlando, FL (US)

(72) Inventor: Frisner Nelson, Orlando, FL (US)

(21) Appl. No.: 16/053,692

(22) Filed: Aug. 2, 2018

Related U.S. Application Data
(60) Provisional application No. 62/541,592, filed on Aug. 4, 2017.
(60) Provisional application No. 62/541,576, filed on Aug. 4, 2017.

(51) Int. Cl. A42B 1/00; A42B 1/02; A42B 1/14; A42B 1/20; A42B 1/24

(52) U.S. Cl. CPC A42B 1/008; A42B 1/02; H02J 7/0045; A42B 1/205; A42B 1/241; A42B 1/14

(57) ABSTRACT

A hat cooling system is disclosed. The hat includes a head portion that is couplable to a user's head. The hat also includes a brim coupled to the head portion and a stowage compartment formed atop the head portion. A battery pack is stowed in the stowage compartment and has an output port. At least two electrical fans are coupled to the brim of the hat. A power wire is coupled to the battery pack by an electrical connector, the power wire has a parallel circuit junction forming two output wires each of the two wires having an electrical connector that is coupled to one of the two fans.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 U.S.C. § 119(e) for provisional patent applications, for any and all parent, grandparent, great-grandparent, etc. applications of the Priority Application(s)).

### Priority Applications

For purposes of the USPTO extra-statutory requirements, the present application claims benefit of priority of U.S. Provisional Patent Application No. 62/541,576 entitled The Coolest Hat, naming Frisner Nelson as inventor, filed Aug. 4, 2017, which was filed within the twelve months preceding the filing date of the present application or is an application of which a currently co-pending application is entitled to the benefit of the filing date.

For purposes of the USPTO extra-statutory requirements, the present application also claims benefit of priority of U.S. Provisional Patent Application No. 62/541,592, entitled The Viper USB, naming Frisner Nelson as inventor, filed Aug. 4, 2017, which was filed within the twelve months preceding the filing date of the present application or is an application of which a currently co-pending application is entitled to the benefit of the filing date.

### BACKGROUND

On sunny hot days it is often preferred to wear a wide-brimmed hat to shade one's head, face, and other parts of the body from the sun. Although slightly effective in keeping a person cool, the conventional hat may not be fully adequate. Accordingly, there is a need for a hat with a cooling system to provide more effective cooling of a person wearing the hat. There is also a need to provide power to a cooling system on a hat.

### SUMMARY

In one aspect, a hat includes a head portion that is couplable to a user's head. The hat also includes a brim coupled to the head portion and a stowage compartment formed atop the head portion. A battery pack is stowed in the stowage compartment and has an output port. At least two electrical fans are coupled to the brim of the hat. A power wire is coupled to the battery pack by an electrical connector, the power wire having a parallel circuit junction forming two output wires each of the two wires having an electrical connector that is coupled to one of the two fans.

In another aspect, a system includes a hat with a head portion configured for sitting on a user's head and a stowage compartment formed atop the head portion and used to store a removable battery pack therein, the battery pack having a charging port and an output port. A battery pack is stowed in the stowage compartment and has an output port. At least two electrical fans are coupled to the brim of the hat. A power wire is coupled to the battery pack by an electrical connector, the power wire having a parallel circuit junction forming two output wires each of the two wires having an electrical connector that is coupled to one of the two fans.

In yet another aspect a hat includes a means for coupling the hat to a user's head and a means for cooling the user. The hat also includes a means for powering the means for cooling, the means for powering being carried by the hat. Further, the hat includes a means for delivering power from the means for powering to the means for cooling.

In addition to the foregoing, other system aspects are described in the claims, drawings, and text forming a part of the disclosure set forth herein. The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the disclosures set forth herein.

### BRIEF DESCRIPTION OF THE DRAWINGS

FIG. 1 depicts a front perspective view of a hat with a cooling system according to an embodiment.

FIG. 2 depicts a rear perspective view of the hat of FIG. 1 with the cooling system according to an embodiment.

FIG. 3 depicts a bottom view of the hat of FIGS. 1 and 2 according to an embodiment.

FIG. 4 depicts a perspective view of the wiring harness for the hat cooling system.

The use of the same symbols in different drawings typically indicates similar or identical items unless context dictates otherwise.

### DETAILED DESCRIPTION

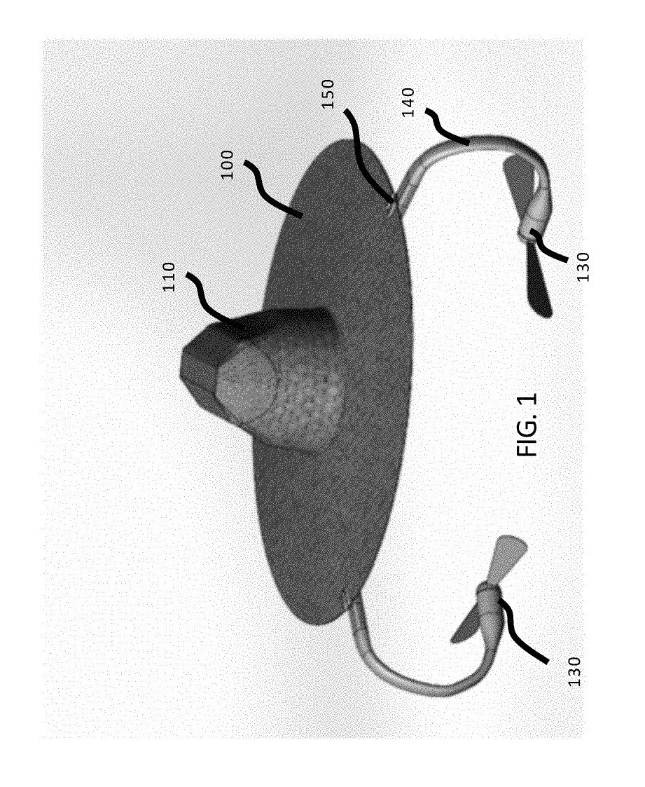

Referring now to FIG. 1, a wide-brim hat 100 is depicted. Hat 100 includes a head portion 110 coupled to a wide brim 120. Although hat 100 is depicted as a wide-brimmed hat, any of a variety of other hats, that may have wider, less wide, or no brim may also be used without departing from the scope of the invention. In accordance with an exemplary embodiment, wide brim hat 100 may be, but is not limited to a Chupalla, or other traditional hats with a slightly extended brim 120.

In an exemplary embodiment, wide brim hat 100 may be made of any of a variety of materials. It may however to be more particularly constructed from straw or other similar inexpensive materials that allow air to pass through hat 100 freely while it is being worn on a user's head. Such hats would be suitable for outdoor activities such as sporting events, gardening, rest and relaxation (lounging), or as a novelty item.

Wide brim hat 100 has one or more fans 130 coupled to wide brim 120. Fans 120 may include any of a variety of low-powered electrical fans which may be powered by a battery pack or the like. In particular, fans 130 may be electrical fans that are couplable to a Universal Serial Bus (USB) interface to power fans 130. In accordance with an exemplary embodiment fans 130 may include an arm portion 140 which may be coupled to wide brim 120 by a clip 150 or other fastening member.

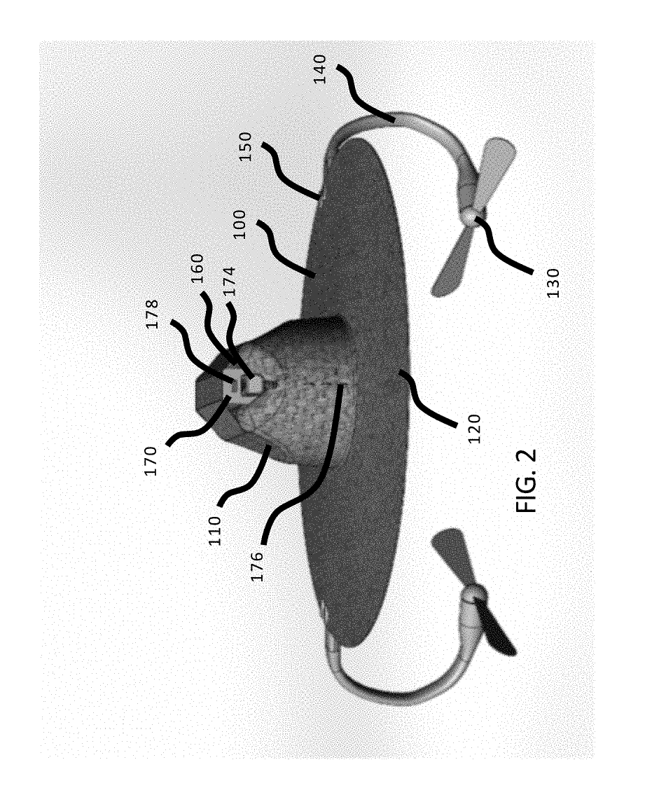

Referring now to FIG. 2, wide brim hat 100 a rear view of wide brim hat 100 is depicted. In the exemplary embodiment depicted, head portion 110 includes a stowage compartment 160 at the top of head portion 110. Stowage compartment 160 is configured to hold a battery pack 170 or other electrical power source. Battery pack 170 includes an output port 172 coupled to an electrical connector 174. In an exemplary embodiment output port 172 is a USB output, but any of a variety of other electrical connection ports may be used. Similarly electrical connector 174 is a male USB connector to couple with output port 172, but may also be any of a variety of electrical connectors compatible with output port 172. Electrical connector 174 is coupled to a cord 176 that is threaded through head portion 110. Battery pack 170 is preferably, but not limited to, a rechargeable battery pack. As a rechargeable battery pack, battery pack 170 has an electrical input port depicted as a micro USB port 178, although any of a variety of input port configurations may be used.

Using the described embodiments of hat 100 on a hot sunny day, a user would be cooled from fans 130 and shaded from the sun by wide brim 120 making the outdoor heat tolerable by the user. Further, a user may move freely given the battery pack 170 provides portable power to fans 130 and can be recharged at the end of the day.

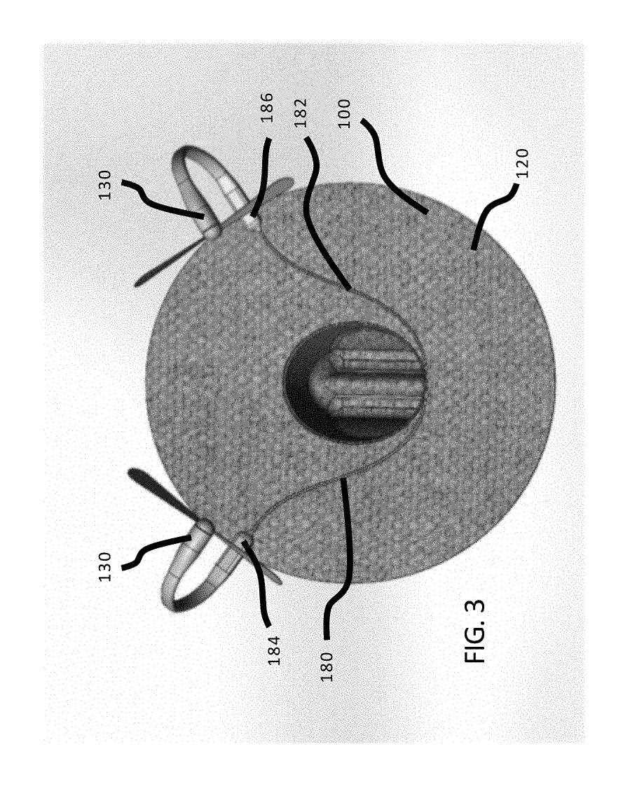

Referring now to FIG. 3, a bottom view of hat 100 is depicted. A first wire 180 connects to one of the fans 130 and a second wire 182 connects to the other of the fans 130. In an exemplary embodiment, wires 180 and 182 terminate at female USB connectors 184 and 186 respectively, such that fans 130 may plugged in. First wire 180 and second wire 182 form a parallel electrical junction connecting to wire 176 depicted in FIG. 2. The two wire USB connection allows forms a wiring harness for supplying power to the two fans 130 from single battery pack 170. Because the wire harness terminates at female connectors 184 and 186, either of the connectors can be unplugged and plugged into other devices such as, but not limited to charging a mobile phone or other electronic devices. Further, because of the two wires 184 and 186, the wires may go around the head of the user and out of the way while in use.

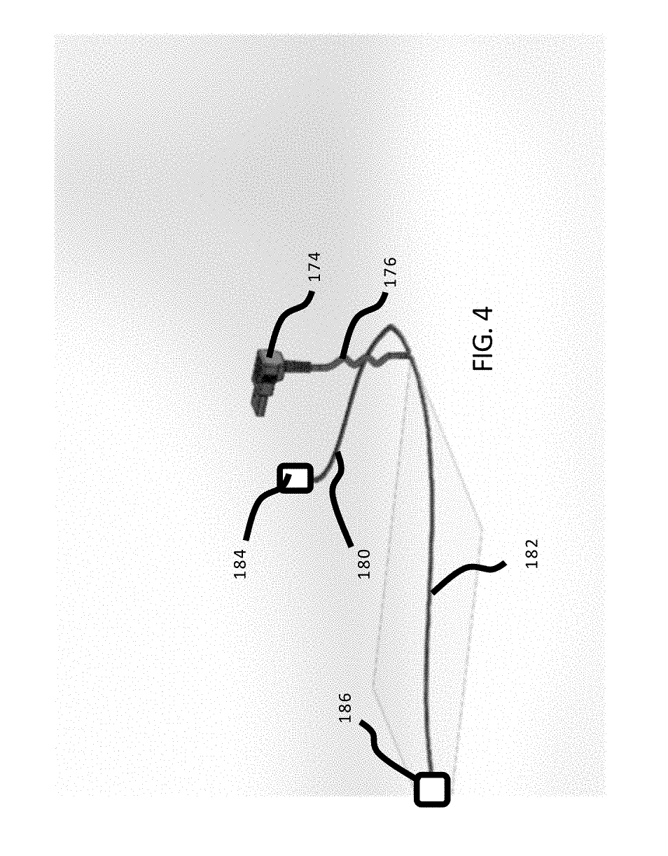

Referring now to FIG. 4, the wiring harness for the hat cooling system. The wiring harness depicted includes two wires 180 and 184 which terminate on one end at female USB connectors 184 and 186 respectively or alternatively other varieties of electrical connectors. The two wires 180 and 182 mate in a parallel connection to combine into a single wire 176. Wire 176 terminates at a male USB connector 174 or other varieties of electrical connectors. The particular embodiment shown is unique in that conventional USB wiring connections do not have parallel connections with two female USB connections connected thereto thereby allowing for powering of multiple devices at the same time.

In a general sense, those skilled in the art will recognize that the various embodiments described herein can be implemented, individually and/or collectively, by various types of electro-mechanical systems having a wide range of electrical components, limited to patentable subject matter under 35 U.S.C. 101. Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A hat, comprising:
a head portion couplable to a user's head;
a brim coupled to the head portion;
a stowage compartment formed atop the head portion;
a battery pack stowed in the stowage compartment and having an output port;
at least two electrical fans coupled to the brim of the hat;
a power wire coupled to the battery pack by an electrical connector, the power wire having a parallel circuit junction forming two output wires each of the two wires having an electrical connector that is coupled to one of the two fans.

2. The hat of claim 1, wherein the hat is a wide brim hat.

3. The hat of claim 1, wherein the hat is formed from plastic.

4. The hat of claim 1, wherein the hat is formed from straw.

5. The hat of claim 1, wherein the output port of the battery pack is a USB port.

6. The hat of claim 1, wherein the fans are removably fastened to the hat.

7. The hat of claim 1, wherein the fans are integrated with the hat.

8. The hat of claim 1, wherein the stowage area is concealed from view.

9. The hat of claim 1, wherein the battery pack includes a micro USB input port.

10. The hat of claim 1, wherein the hat may be used to charge a mobile phone when one of the output wires is detached from the fan and coupled to a mobile phone charging cord.

11. A hat, comprising:
a head portion configured for sitting on a user's head;
a stowage compartment formed atop the head portion and used to store a removable battery pack therein, the battery pack having a charging port and an output port;
a battery pack stowed in the stowage compartment and having an output port;
at least two electrical fans coupled to the brim of the hat;
a power wire coupled to the battery pack by an electrical connector, the power wire having a parallel circuit junction forming two output wires each of the two wires having an electrical connector that is coupled to one of the two fans.

12. The hat of claim 1, wherein the hat is formed from plastic.

13. The hat of claim 1, wherein the hat is formed from straw.

14. The hat of claim 1, wherein the output port of the battery pack is a USB port.

15. The hat of claim 1, wherein the fans are removably fastened to the hat.

16. The hat of claim 1, wherein the fans are integrated with the hat.

17. The hat of claim 1, wherein the stowage area is concealed from view.

18. The hat of claim 1, wherein the battery pack includes a micro USB input port.

19. The hat of claim 1, wherein the hat may be used to charge a mobile phone when one of the output wires is detached from the fan and coupled to a mobile phone charging cord.

20. A hat, comprising:
a means for coupling the hat to a user's head;
a means for cooling the user;
a means for powering the means for cooling, the means for powering being carried by the hat;
a means for delivering power from the means for powering to the means for cooling.
